(19) United States
(12) Patent Application Publication
(10) Pub. No.: US 2016/0269917 A1
(43) Pub. Date: Sep. 15, 2016

(54) Method of Acquiring, Auditing and Interpreting Radiation Data for Wireless Network Optimization

(71) Applicant: Ontegrity, Inc., Framingham, MA (US)

(72) Inventors: William A. Hillegas, JR., Lancaster, PA (US); Mirela Marku, Weston, MA (US)

(73) Assignee: Ontegrity, Inc., Framingham, MA (US)

(21) Appl. No.: 14/644,716

(22) Filed: Mar. 11, 2015

(51) Int. Cl. H04W 24/02; G05D 1/10; H04W 64/00

(52) U.S. Cl. CPC H04W 24/02; H04W 64/006; G05D 1/101

(57) ABSTRACT

The present invention is a method for surveying, monitoring and auditing cell towers and antennas emitting radiation such as radio frequency and infra-red radiation using unmanned aerial vehicles. The method employs vertical measurements of signal strength, interference and radiation with a mobile platform for evaluating test data and optimizing network performance and safety. The invention is particularly suited for monitoring and auditing RF antennas situated in a variety of terrains.

### BACKGROUND

Present day telecommunications (telecom) networks are disparate, multi-vendor complex environments. Supporting the high data traffic demand requires telecom carriers to expand network capacity, requiring huge capital investments. Wireless operators need to collect data from their networks to test and measure coverage and quality. The tests and measurements have been conducted in what is known in the industry as a “walk-test” or “drive-test”, meaning that a human operator would walk or drive with a mobile device to check signal availability and strength. However, with the continuously changing radio frequency (RF) environment, it is not practical, and very expensive, to obtain network information with walk-test or drive-test solutions.

To design and monitor a network the wireless carrier provider sets up various types of drive tests. Drive tests are performed in cellular networks regardless of the technology used. Some of the most common standards are set out below.

The Global System for Mobile Communications (GSM) is a standard developed by the European Telecommunications Standards Institute (ETSI) to describe protocols for second generation (2G) digital cellular networks used by mobile phones. It is currently the default global standard for mobile communications. The GSM standard was developed as a replacement for first generation (1G) analog cellular networks, and originally described a digital, circuit-switched network optimized for full duplex voice telephony. This was expanded over time to include data communications, first by circuit-switched transport, then packet data transport via General Packet Radio Services (GPRS) and Enhanced Data rates for GSM Evolution (EDGE).

The code division multiple access (CDMA) uses a “spread-spectrum” technique whereby electromagnetic energy is spread to allow for a signal with a wider bandwidth. This allows multiple people on multiple cell phones to be “multiplexed” over the same channel to share a bandwidth of frequencies. With CDMA technology, data and voice packets are separated using codes and then transmitted using a wide frequency range. Since more space is often allocated for data with CDMA, this standard became attractive for 3G high-speed mobile Internet use. Universal Mobile Telecommunications System (UMTS) is a third generation mobile cellular system for networks based on the GSM standard. Developed and maintained by the 3rd Generation Partnership Project (3GPP), UMTS is a component of the International Telecommunications Union IMT-2000 standard set and compares with the CDMA2000 standard set for networks based on the competing CDMAOne technology. UMTS uses wideband code division multiple access (W-CDMA) radio access technology for greater spectral efficiency and bandwidth to mobile network operators. UMTS specifies a complete network system, which includes the radio access network, UMTS Terrestrial Radio Access Network (UTRAN), the core network Mobile Application Part (MAP), and the authentication of users through subscriber identity module (SIM) cards. The technology described in UMTS is sometimes also referred to as Freedom of Mobile Multimedia Access (FOMA) or 3GSM.

Long Term Evolution (LTE) is telephone and mobile broadband communication standard. LTE is a standard for wireless data communications technology and a development of the GSM/UMTS standards. The goal of LTE was to increase the capacity and speed of wireless data networks using new digital signature processing (DSP) techniques and modulations that were developed around the turn of the millennium. A further goal was the redesign and simplification of the network architecture to an Internet Protocol (IP)-based system with significantly reduced transfer latency compared to the 3G architecture. The LTE wireless interface is incompatible with 2G and 3G networks, so that it must be operated on a separate wireless spectrum.

In the case of the drive test, data is collected on vehicle movement, in the case of a walk test data is collected with a receiver carried by an individual. Common data assessments points are described as Key Performance Indicators (KPIs), which are indicators to determine if a device, equipment or a wireless network meets certain reliability criteria predicate to deployment.

In wireless networks the following KPIs are defined

Accessibility

Retainability

Integrity

Availability

Mobility

Although analysis of KPI can identify problems such as dropped calls, the drive tests allow a deeper analysis in field, identifying areas of each sector of coverage, interference, evaluation of network changes and various other parameters.

When performing testing and measuring, particularly during walk tests, there is also the issue of worker safety, including the physical safety aspect of climbing towers or other risky physical exposure to access remote sites. There is also the safety factor of excessive exposure to radio-frequency (RF) radiation. At high levels, RF radiation can cook human tissue, cause cataracts and induce temporary sterility, among health issues. RF radiation poses a particular risk to workers doing an in person test as they can be exposed to high levels of radiation.

As to the public, the antennas that were formerly located on sites remote from traffic where signals largely radiated from remote towers off-limits to the public, are now located on rooftops and in public parks and stadiums, and are often disguised for aesthetic reasons,

Where there is a danger of excessive RF radiation, such as with physical proximity to a source, barricades and warning signs are often used to protect individuals from excessive exposure to RE radiation, the waves of electric and magnetic power that carry signals. The power isn't considered harmful over a distance, but it can be a risk for workers, emergency responders and residents standing directly in front of an antenna.

At very high levels, the thermal effects of RE radiation can cook human tissue and potentially cause cataracts, temporary sterility and other health issues. The World Health Organization in 2011 categorized RF radiation as a possible carcinogen, and Federal Communications Commission (FCC) guidelines note studies showing relatively low levels of RE radiation can cause “certain changes in the immune system, neurological effects, behavioral effects,” and other health issues, including cancer.

Unmanned Air Vehicles (UAV) come in a variety of shapes and sizes and have many applications in military, commercial, and research endeavors. Aerial drones are also known by several different names and acronyms, including:

Remotely Piloted Vehicle (RPV)

Unmanned Aerial Vehicle (UAV)

Unmanned Aircraft (UA)

Unmanned Aircraft System (UAS)

Unmanned Combat Aerial Vehicle (LICAV)

The word “drone” can also be used to refer to land, water and space vehicles. UAVs come in a variety of shapes, sizes and configurations, selected for the tasks to be performed. They can be rotor type or fixed wing, depending on the terrain and application.

### SUMMARY OF THE INVENTION

The present invention employs drones or UAVs for HetNet Optimization, specifically the UAVs are equipped to take vertical measurements of a wireless network's performance. Vertical measurements may also be used to enhance and tune 3D modeling of RF signals. The technique is also effective in areas where traditional measurement methods do not yield reliable results, such as the signal strength over a frozen body such as a lake or pond where there is a free space drop.

A Heterogeneous Network (HetNet) involves a mix of radio technologies and cell types working together. Wireless subscribers' expanding use of data intensive applications like rich multimedia services driven by smart phones, laptops, tablets and emerging devices are putting intense pressure on network capacity for wireless providers.

Commercial carriers today are trying to meet the current and future capacity challenges by improving, densifying and complementing the macro layers with low power, energy efficient small cell underlayment such as metro, micro and femto cells. Small cells are low-powered radio access nodes that operate in licensed and unlicensed spectra that have a range of 10 meters to few kilometers. They are “small” compared to a mobile macrocell, which may have a range of a few tens of kilometers. .HetNet deployments are already possible in the first LTE release and will be further extended as both vendors and wireless carriers see a great potential to relieve macro traffic congestion and offloading.

Various embodiments relate to UAVs are employed to conduct testing and RE readings, and are in communication with ground control systems to control such UAVs.

The combination of site topologies is mostly happening in complex urban environments where most of the subscribers live, work and entertain making it very challenging to design and manage with existing RF planning solutions. For understanding the present system and methods, the following terms are defined:

Distributed Antenna System (DAS), which is a combination of nodes where a node is an antenna in the distributed antenna system. a network of spatially separated antenna nodes connected to a common source via a transport medium that provides wireless service within a geographic area or structure. DAS antenna elevations are generally at or below the clutter level and node installations are compact;
Outside Distributed Antenna System (oDAS) is a DAS located outdoors;
Indoor Distributed Antenna System (iDAS) is a DAS located indoors.
A node is a radiation source, usually an antenna:

Distributed Antenna System or DAS is a network of spatially separated antenna nodes connected to a common source (Head End) via a transport medium (fiber or coax cable) that provides wireless service within a geographic area.

Distributed Antenna System (DAS) networks are being deployed to provide coverage in targeted locations, moving radios closer to the subscriber, and or to providing additional call and data-handling capacity in areas with concentrated demands for wireless service.
A DAS Network consists of three primary components:
1. A number of remote communications nodes (DAS Nodes, each including at least one antenna for the transmission and reception of a wireless service provider's RF signals,
2. A high capacity signal transport medium (typically fiber optic cable) connecting each DAS Node back to a central communications hub site
3. Radio transceivers or other head-end equipment (hub) located at the hub site that propagates and/or converts, processes or controls the communications signals transmitted and received through the DAS Nodes.
   Depending on the particular DAS network architecture and the environment in which it is deployed, DAS Nodes may include equipment in addition to the antennas, e.g., amplifiers, remote radio heads, signal converters and power supplies.

### Capital Expenditure (CAPEX);

### Operational Expenditure (OPEX).

3D RF modeling using UAV's methodology can help with these important aspects of RF performance and design;
Estimating radio coverage in-building and outdoor from rural to dense urban environment.
Design an HetNet with coherent propagation models and homogenous engineering margins by looking at the 3D measurement (vertical UAV signal measurements)
Measuring the interference between indoor & outdoor and between overlays and underlays.
Identifying key areas to install and small cell or oDAS node to optimize the CAPEX/OPEX needs.

This invention will allow the Commercial Wireless Carrier to effectively monitor the network performance and ultimately avoid over dimensioning (hardware and the amount of spectrum or frequency dedicated to the network, antennas and base stations). The method helps avoid over-dimensioning (spending money prematurely), and under-dimensioning the network, i.e., not spending money when there is a need which then results in dissatisfied customers who become more likely to churn.

Current solutions are limited. RF planning tools are only geared towards green field (no existing coverage or equipment in place) network planning and require qualified technicians driving and collecting data. This invention will ensure good network performance, and minimized both CAPEX and OPEXX expenditures, while simultaneously satisfying the network customer's quality of service requirements.

Commercial wireless operators face an impending “data tsunami” with analysis estimating 82.5% smart device penetration and a 78% increase in mobile data traffic consumption by 2016, while being strapped by limited spectrum and CAPE/OPEX constraints. Mobile communication networks are very expensive to build and maintain. More importantly today's dense urban environment has various solutions incorporated, macro cells, small cells and oDAS etc. The later will present even more optimization challenges to carriers or third party vendors when is deployed as a neutral host solution. The present invention will present significant cost savings to operators. In order to optimize both the CAPEX and OPEX of these networks while meeting defined Quality of Service (QoS) requirements, using the present disclosed systems and methods, mobile operators will be able to:
Define network capacity in terms of useful customer centric KPIs. Some KPI mostly used to monitor network performance include:
   Minutes per dropped call (summary of all traffic minutes divided by the number of dropped calls during a period of time)
   Blocking/Congestion: Call attempts that meet blocking because all resources are occupied. The network is dimensioned to meet a certain traffic level in the busiest hours, typically dimensioned to drop 2-5% of total mobile connection attempts.
Install capacity for various network elements
Exploit “soft” capacity properties of modern mobile network technology

The amount of traffic that can be carried within a mobile communication carrier depends on the radio conditions under which the users' mobile devices operate. A user that has line of sight to a cell antenna will have a larger capacity than a distant mobile device. By measuring the signal strength at a given point and comparing it with the theoretical loss signal from the site the operator can determine the throughput at any given point. UAVs can measure the signal not only on the antenna level but around high rises buildings to determine the quality of signal expected to penetrate the buildings, which will help operators design the proper i-DAS.

Carriers today are implementing a layered approach. Macro sites are providing an “umbrella” coverage, while small cells are providing capacity where needed. Today's measurement systems do not offer “vertical” signal measurements. Traditionally, drive testers drive on street level, (car) and measure only one layer of coverage. Using UAVs to measure radiation strength vertically offers a layered approach to testing and optimization.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a UAV with sensors;

FIG. 2 is a schematic view of a distributed antenna system;

FIG. 3 is a diagram of components for data collection and processing in a TEMS environment;

FIG. 4 is a view of a UAV taking vertical readings of RF signal strength;

FIG. 5 is a 3D representation of a signal pattern from a radiation source;

FIG. 6 shows 3D renderings of a signal pattern contrasted with a 2D rendering.

### DETAILED DESCRIPTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. Furthermore, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

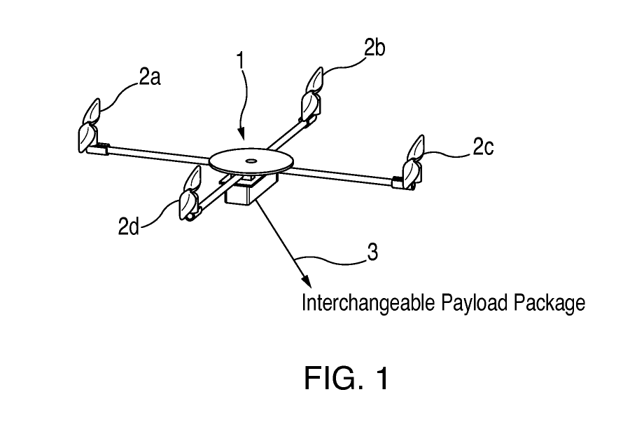

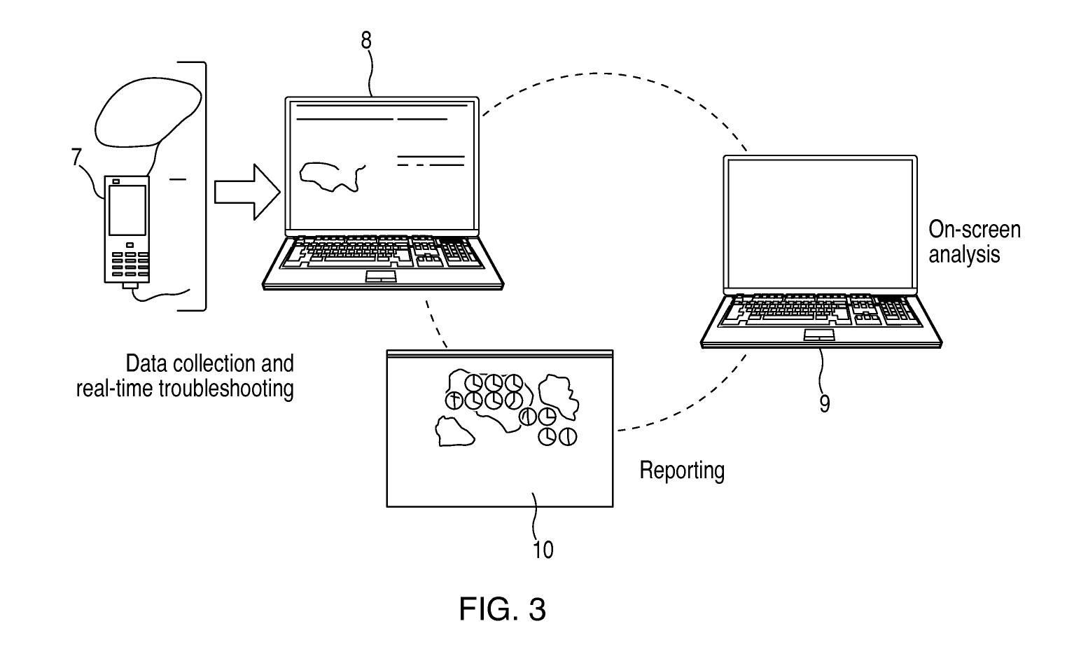

Turning to FIG. 1, the UAV 1 is shown having rotors 1a, 1b, 1c and 1d. The UAV carries an interchangeable payload package 3, which comprises various components. The package 3 may be any combination of an RF monitor 3a, typically a wide band receiver that scans the environment and records the frequencies present, an IR detector 3b, a temperature/humidity sensor 3c, a TEMS module 3d and an interference monitor 3e. The RF monitor 3a is a wide band receiver that scans the surrounding environment and records the detected frequencies that are present. The TEMS module 3d provides further analysis and measures network components and performance as shown in FIG. 3. The payload package 3 may also carry a camera 3f as part of its payload for such purposes as reconnaissance and surveillance missions. The thermometer 3c may also be an IR thermometer for measuring heat output from a source. These components are located in positions that will not be affected by the operation of the rotors where a rotor-type UAV is employed, e.g., below the rotors 2a, 2b, 2c and 2d or in front of a frame that supports the rotors.

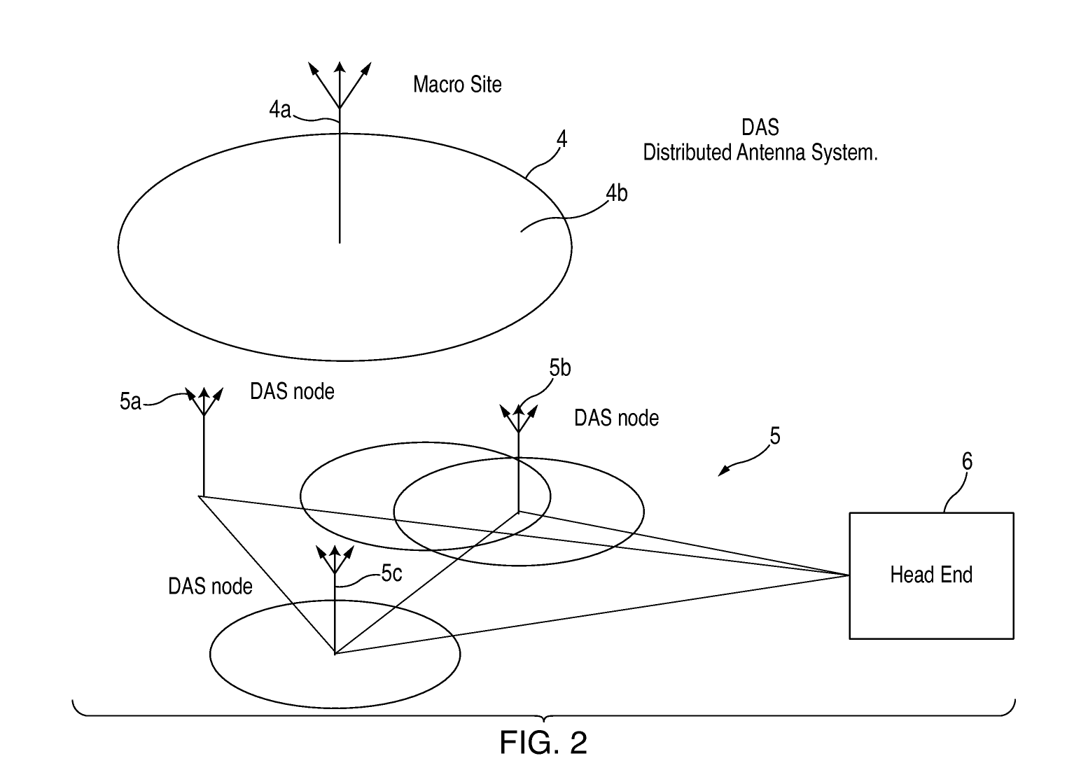

Turning to FIG. 2, a typical macro site DAS component 4 is shown in schematic form, having an axis 4a and a radiation circumference 4b. The macro site is typically an antenna. Shown also in FIG. 2 is a DAS 5 comprising three DAS nodes 5a, 5b and 5c, each in communication with a head end 6. Each of the DAS nodes 5a, 5b and 5c are radiation emitters as shown in the component 4.

The ground control site (GCS) (not shown) may facilitate camera operations through the applications interface. In the GCS, there is software for displaying the video information from the camera and archiving the video data. The on board system receives video data from the camera and inputs this information to the on board camera control software. The on board camera control software is responsible for processing video information and providing this processed video information as an input to the on board RE transceiver. The transmitted video information is received at the ground station where it serves as input to the ground video display software. The GCS video display software displays the video on the GCS graphical user interface (GUI) and archives the video in a database for future analysis.

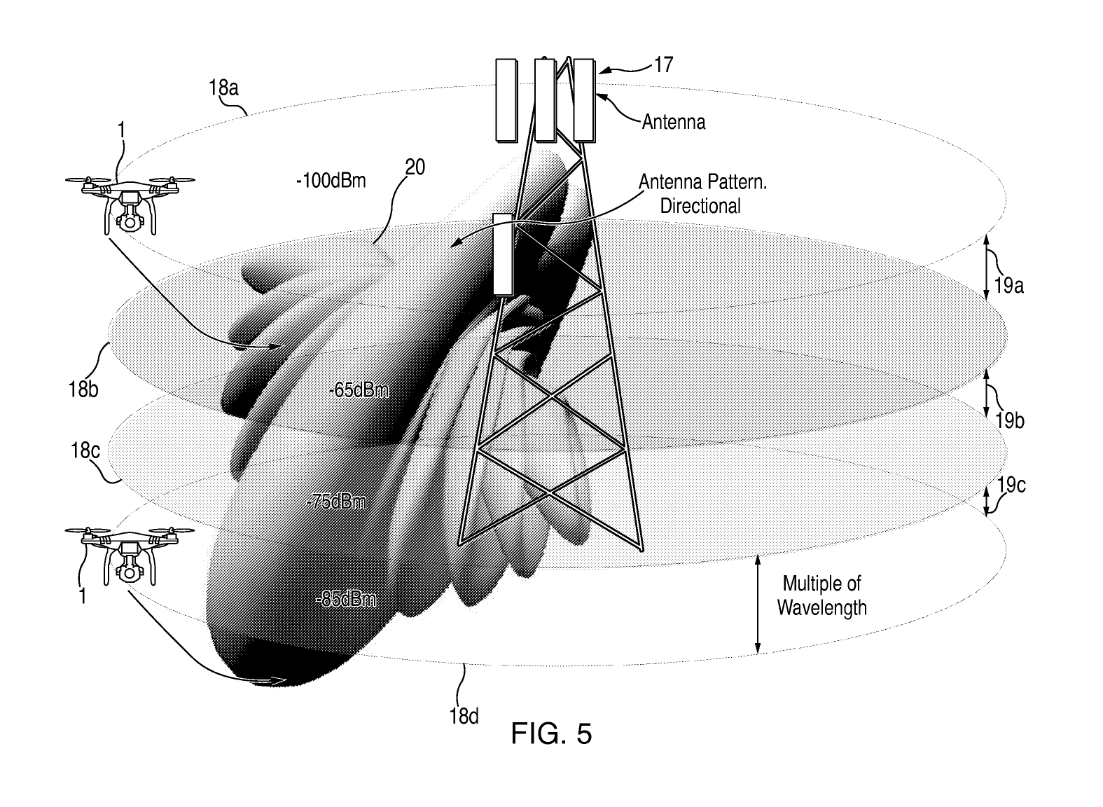

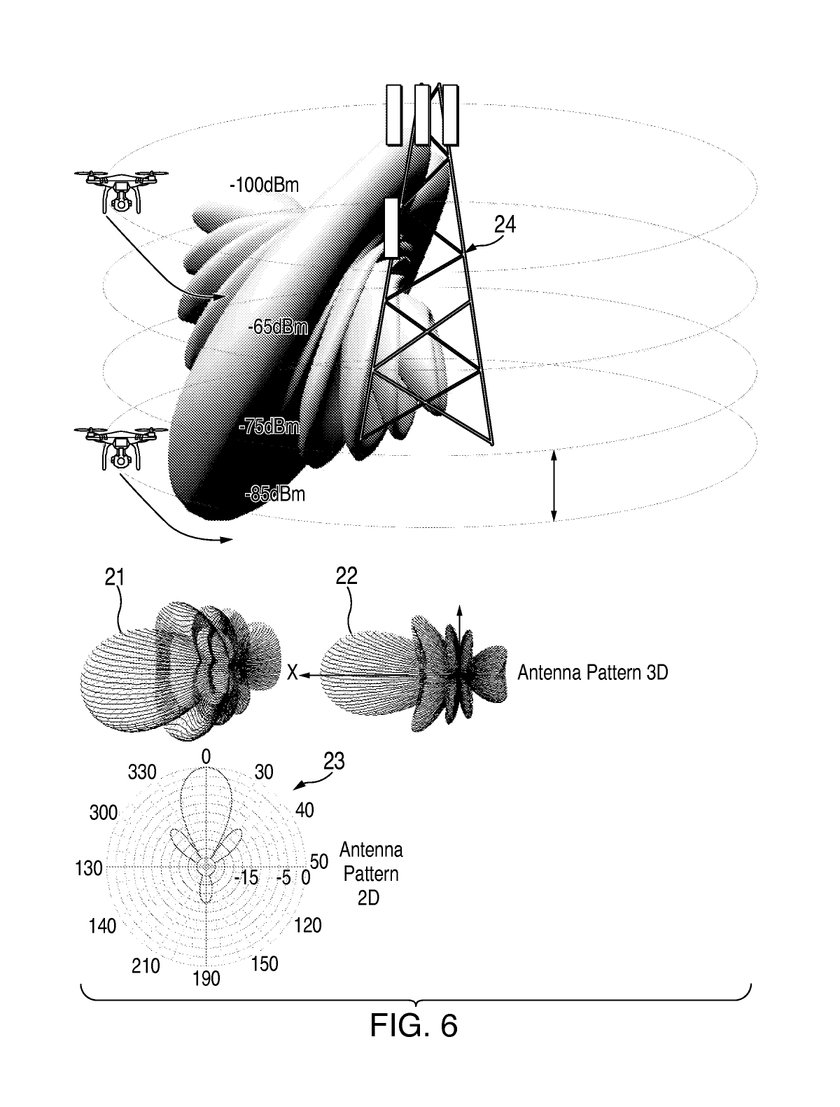

The environmental information recorded by the UAV 1 can be used to locate areas of concern, such as areas or pockets of abnormally high heat, RF radiation, noise or humidity. The environmental information can also be used to generate visual representations, such as histograms, of the environmental conditions within the monitored environment. For example, the environmental information recorded by the UAV 1 can be used to generate data representations (e.g., graphs and spreadsheets) that reflect a time history of the monitored environmental conditions, in addition to the radiation patterns shown in FIGS. 5 and 6.

Patterns can be detected in these data representations to automatically determine, for example, whether any corrective actions need to be taken. For example, if the environmental information shows that a particular location or locations is abnormally hot or emitting excessive RF radiation during a particular time period each day (e.g., 9:30 AM on Mondays, when the machine might be under a heavy load), an administrator or an engine could choose to take extra temperature control measures during that time such as, for example, moving some equipment to another location to distribute the heat generation, or adjusting the airflow vents in the area to better cool the environment. Such patterns may be represented visually by a graph or chart.

The UAV 1 also includes navigational features, such as an altimeter 3g, a radio-frequency identification (RFID) sensor 3h, a compass 3i (e.g., an electronic compass), and a proximity sensor 3j. The compass 3i provides a heading or bearing of the UAV 1 (e.g., by providing information that allows a relative bearing to be calculated) and can be an analog or digital compass. The altimeter 3g provides an altitude of the UAV 1, and can be implemented as a downward-facing infrared altimeter or an ultrasonic altimeter. The altimeter 3g may be especially useful in vertical sensing of tall structures. The proximity sensor 3j provides collision detection functionality using infrared or ultrasonic obstacle detection techniques.

Additional proximity sensors can be located on the UAV 1 to provide an increased range of coverage for detecting collisions and obstacles. The UAV 1 may also include a horizon detection device (e.g., a camera 3f) for stabilizing and properly orienting the UAV 1 as well as for territorial surveillance. The RFID sensor 3h provides a position of the UAV 1 relative to one or more beacons. The navigational features communicate with a navigation engine to navigate the UAV 1. The navigation engine may be an application running on a processing device associated with the UAV 1, and uses values provided by the navigational features to navigate the UAV 1. In some embodiments, the processing device may be on board UAV 1 and thus the navigation is performed locally. In alternative embodiments, the processing device may be located remotely from UAV 1. In such cases, UAV1 may send sensor data to the processing device wirelessly and may receive navigation information from the processing device also wirelessly.

The UAV 1 also includes a report generation engine 3k, a combination of hardware and software for analyzing data collected that may be processed locally within the UAV 1, or the data or some portion of the data may be transmitted down to a computer or phone. Analysis using algorithms may be conducted as the data is streaming in or after collection is completed. In some examples, the report generation engine 3k generates reports that provide the environmental conditions of a particular location with the particular RF readings. The report generation engine 3k uses data provided by the RF monitor 3a (a sensor), the altimeter 3g, the RFID sensor 3h, the thermometer 3c, the humidity sensor 3c, and the compass 3i to generate reports that are transmitted to a central location using a transmission device. In some examples, the transmission device transmits reports using one or more wireless transmission protocols, such as WiFi, Bluetooth, radio communication, and the like. An example of a protocol that can be used is XBee wireless communication protocol (IEEE 802.15.4) which uses low power radio frequency at 2.4 GH.

In some examples, the system includes a plurality of beacons configured to transmit respective pilot signals that can be detected by sensors such as an RFID sensor 3h on the UAV 1. The UAV 1 uses the pilot signals to navigate to various locations within a monitored environment such as the DAS 5 shown in FIG. 2. The beacons can be placed at locations within a monitored environment to act as waypoints for the UAV 1, and may also transmit a Beacon ID that uniquely identifies its associated beacon.

In an embodiment adapted for RF information gathering, the UAV 1 is equipped with a portable RF information gathering sensor 3a, such as an Ascom TEMS 3d or equivalent, to gather RF information from cell towers such as 5a, 5b and 5c depicted in FIG. 2. The sensor tool 3d allows for troubleshooting, verification, optimization and maintenance of wireless networks, as well as gain insight into the subscriber perspective by performing service testing directly on the end terminal.

Various types of unattended, mobile test probes can place test calls throughout the network and transmit the data for processing and reporting. Functions may include:
Automatically collect network data 24/7 over a variety of wireless technologies
Test voice and data service quality, with support for scanning
Provide continuous feedback on the quality of service as experienced by customers
Collect data from networks for quality monitoring, benchmarking, and troubleshooting
Process statistical data and detailed data to detect faults, capacity bottlenecks, and configuration problems
Gain insight into the end-user perception of the network to reduce churn and increase revenue
   Turning to FIG. 3 a typical processing system for TEMS 3d acquired data is shown in the diagram. Data collected by the TEMS component 3d is transmitted or downloaded to a base 7, here shown as a smart phone 7. For the purpose of dedicated scanning, a Sony Ericsson TEMS phone can go into a special scan mode which is not available in commercial phones and has superior performance compared to an ordinary cell phone. In scan mode, the channel selection is controlled by the user, unlike an ordinary phone mode which is controlled by the network.

The data is then transmitted to a processor 8 here shown as a computer, and from there the processed data is transmitted to a screen 9 for visual display and analysis. The output of 9 or of 8 directly may be used to generate reports 10 showing the results of the analysis performed

For the method as used to measure and optimize wireless (HetNet) systems, the main purposes of a UAV 1 wireless network test are:
Performance Analysis of the wireless network.
Data gathered with UAV 1 may include the following parameters that will be used by the subject matter analysts to determine the “health” of the network.
   Signal Strength levels
   Signal Quality
   Interference
   Dropped Calls
   Call statistics
   Handover information
   Neighboring cell information
      The information may be used to perform the following:
New Site Integration and Change Parameters of existing sites: integration of new sites and changing the parameters of existing sites, such as antenna azimuth, downtilt and tower levels for example
   Each time a new site is introduced into a wireless network various measurements will need to be performed to ensure the site is operating properly. Some of them require field visit. A UAV 1 can be used to gather both performance and coverage data to help the engineers optimize decision making.
Marketing: output signal strength for speed and size and benchmarks of network performance quality and coverage
   Coverage and performance data of any given network can be used for marketing purpose. A UAV 1 can also be used to determine the population numbers around any given wireless site. These numbers will help engineers dimension their networks.
Benchmarking: The sensor tools may be integrated with any phone-based test tool developed to measure the performance and quality parameters of wireless networks. The tool will collect measurement and event data at the antenna level (including oDAS and small cell environments) for immediate monitoring or for further processing.
   Various organizations gather data from different wireless carriers in order to compare and determine their performance from the customer point of view. Many times wireless carriers gather data from their competitors in order to perform benchmark analysis. Right now drive testing (or walk testing) to gather networking benchmarking data is the way mobile network operators can collect accurate competitive data on the true level of their own and their competitors technical performance and quality levels. Benchmark Data gathered using a UAV 1 will be used to measure several network technologies and service type simultaneously to very high accuracy, to provide directly comparable information regarding competitive strengths and weakness.

The sensor tools may be integrated with any phone-based test tool developed to measure the performance and quality parameters of wireless networks. The present invention may also be employed for measuring electromagnetic field (EMF) strength and WiFi deployments.

The traditional 2D RF Model tuning is a complex, multi-step procedure to deliver rugged and accurate radio propagation model well adapted to the different environments of a network. The model tuning process involves RF measurement data gathering, a battery of tests to audit them, then the models are calibrated depending on the selected strategy that can range from small to county wide areas and a large variety of site topologies.

A radio propagation model is a key algorithm used in wireless network design and optimization Propagation models can be applied for a wide variety of scenario, in-buildings or outdoors, from macro to pico cells, and from high to low frequencies and is aimed to providing the most comprehensive, reliable and efficient wireless coverage and capacity analysis within a given area.

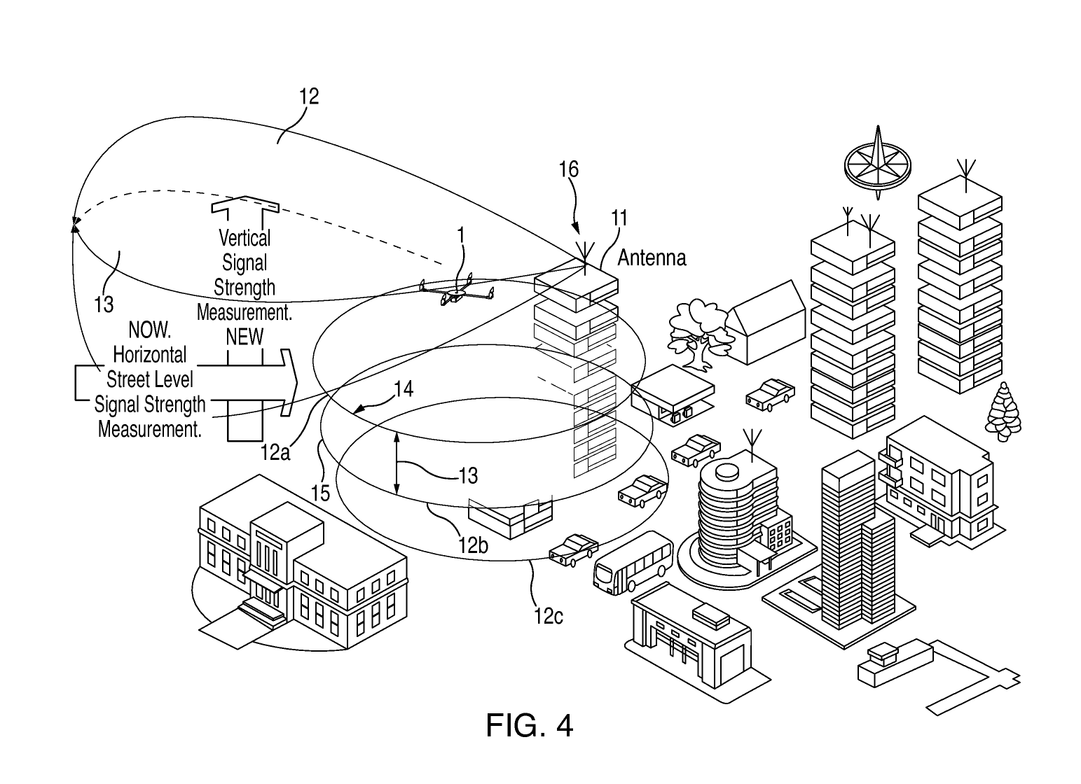

To analyze a RF prediction model and determine the accuracy, an iterative process called model tuning has to be deployed to adjust the model to accurately reflect circumstances, a process well known to those of skill in the art FIG. 4 shows a typical survey by UAV 1 of an antenna 11, showing the contrast between the traditional, horizontal street level measurements of signal strength with the vertical signal strength methodology of the present invention. The range of field strength is depicted as a teardrop shape 12, with an inner teardrop 13 with dashed line to show three dimensional effects. The UAV 1 approaches the antenna 11 by whatever path is physically feasible and efficient. Once the UAV 1 is in proximity to the antenna 11 (radiation source), UAV 1 may adopt different flight paths to survey and audit the antenna 11.

The result of the survey will be survey data. In general this data contains for each coordinate one or more field-strength values. In the embodiment shown, the RF strength value is the Receive Signal Strength Indicator (RSSI). The UAV1 will collect this data going vertically and in incremental circles 12a and 12b, around the antenna 11. The vertical step 13 between flight paths 12a and 12b is preferably a multiple of a wavelength. The substantially circular flight path 12a about antenna 11 is conducted at an altitude 14 (height above ground level 12c), and the second substantially circular flight path 12b is conducted at a second altitude 15 (height above ground 12c), separated by the vertical displacement 13. The data collected data may be split in to two separate files. These data files are correlated with each other. Each line in the file holding a measurement location (vertical height or altitude) should be represented in the other file with a line that holds the field-strength at the location.

The UAV 1 may follow any of several flight paths for reading and harvesting data suitable for use in vertical radiation analysis. The vertical flight path is preferably where the UAV 1 flies from the antenna 11 centerline 16 to the ground level 12c at a speed that will be predetermined, depending on the transmitted frequency. The horizontal flight path is where the UAV 1 traverses a circumference about the antenna 11 (radiation emission source) at different altitudes, here shown as 14 and 15 (heights), separated by the vertical gap 13, the vertical gap 13 being a defined vertical height such as two feet. For each of these routes, each coordinate represents a position where a field-strength measurement took place and the altitude of the UAV 1 (height from the ground level).

Mathematical verification: The accuracy of a 3D model predicting RF propagation can be expressed in the following KPIs (Key Performance Indicator):
Average error of predicted to the measured field strength
Standard deviation
Correlation of the predicted to the measured field-strength.
   The calculation file is the data file where the calculations are performed.

### Test Site Setup:

The test site is the location where the transmitter is located which the receiver phone will be receiving during the survey. There are a number of subjects that need attention when setting up such a site.
The site: The first a site location is determined. For this purpose, a phone mounted GPS is preferable. Second, the height of the antenna centerline (16 in FIG. 4) should be determined and recorded. Sensors mounted on the UAV 1 will be used to determine antenna height.
Robustness: The measurements are taken in an active site or with a transmitter connected to the antenna. It is important to have a stable signal for the duration of the survey. The transmitter should:
   Be able to send continuously the required power
   The frequency of the transmitter needs to be stable
   Have a reliable and sufficient power supply that will provide power for the duration of the test.
Antenna: in many cases the easiest method is to install an omnidirectional antenna. However when using live sites there are occasions where a directional antenna is preferable. In both situations the antenna gain is very important for a successful survey. An antenna's power gain or simply “gain” is a key performance figure which combines the antenna's directivity and electrical efficiency. As a transmitting antenna, gain describes how well the antenna converts input power into radio waves headed in a specified direction. Each antenna has a manufacturer specific gain, which varies depending on whether the antenna is directional or omnidirectional.

### Data Analysis Algorithm

Generally, the measurement/propagation algorithm converts data with an X-Y orientation to a Y-Z axis. This is a description of the algorithm used for the proposed model tuning and optimization of the model based on actual signal strength readings from the UAV 1. The predictions of the tuned model are compared with those of the recommended levels and verified in comparison with some electric field strength measurements obtained by UAV 1 measurement system proposed.

Initially a semi-empirical method will include the effects of terrain, scattering objects of the environment and other propagation conditions, among various factors and corrections. The goal is to propose an optimization algorithm which can improve the accuracy of the predictions.

On the other hand, this high degree of freedom and the complexity of the model formulas may cause divergence and instability in the tuning process. Based on these considerations, the optimization algorithm is designed to tune the model parameters. In this algorithm, the genetic optimization technique is used to perform a global search for the best set of parameters. The resulting tuned model is compared with the common model via some electric field measurements obtained using a UAV-based system. It should be noted that this comparison is presented to show the efficiency of the proposed algorithm in reduction of prediction error. In practice, the algorithm can be used as a professional tool to obtain the tuned model parameters in every propagation zone, if a comprehensive set of measurement data is available.

Measurements.

The radio wave propagation measurements can be performed at any LTE frequency, for example 850 Mhz block, using an UAV equipped with a Scanner.
Processing of the measured data.
Before starting the optimization algorithm, the raw measured electric field must be processed. The resulted field strength is used as the processed measured field strength for comparison with the simulation results.
Extraction of the field strength for a given percentage of time.

According to International Telecommunications Union (ITU) <http://www.itu.int/en/about/Pages/default.aspx)> Recommendations (ITU-R) P.1546 <http://www.itu.int/rec/R-REC-P.1546/en>, a method for point-to-area predictions for terrestrial services in the frequency range 30 MHz to 3000 MHz, the field strength at each measurement point is calculated for a given percentage of time inside the range from 1% to 50%. This is done by fitting a normal distribution to the different electric field strengths which are measured at one measurement point. Thus, the field strength which will be exceeded for t % of times at each receiver location can be given by:

E(t)=ET(median)+Qi(t/100)σT dB(μtV/m) (1)

where ET (median) is the median field strength with respect to the time at the receiver location, Qi(x) is the inverse complementary cumulative normal distribution as a function of probability and σT is the standard deviation of normal distribution of the field strength at the receiver location.

### Extraction of the Field Strength for a Given Percentage of Locations

According to ITU-R P.1546 recommendation, in area-coverage prediction methods, it is intended to provide the statistics of reception conditions over a given area, rather than at any particular point. The field strength value at q % of locations within an area represented by a square with a side of 200 m is given by:

E(q)=EL(median)+Qi(q/100)σL dB(μtV/m) (2)

where EL(median) and σL are the median and standard deviation of field strength over the defined area, respectively. It should be noted that q can vary between 1 and 99.

### The Field Strength Prediction Formulas

The following formulas are used according to the recommendation for field strength prediction:

$$\begin{matrix}{l}_{d} = {log}_{10} ( d ) & ( 3 ) \\ k = \frac{{log}_{10} ( \frac{{h}_{1}}{9.375} )}{{log}_{10} 2} & ( 4 ) \\ {E}_{1} = ( {a}_{0} {k}^{2} + {a}_{1} k + {a}_{2} ) {l}_{d} + ( 0.1995 {k}^{2} + 1.8671 k + {a}_{3} ) & ( 5 ) \\ {E}_{ref 1} = {b}_{0} [ exp ( - {b}_{4} {10}^{{l}_{d}^{b 5}} ) - 1 ] + {b}_{1} \cdot exp [ - {( \frac{{l}_{d} - {b}_{2}}{{b}_{3}} )}^{2} ] & ( 6 ) \\ {E}_{ref 2} = - {b}_{6} {l}_{d} + {b}_{7} & ( 7 ) \\ {E}_{ref} = {E}_{ref 1} + {E}_{ref 2} & ( 8 ) \\ {E}_{off} = {c}_{5} {k}^{{c}_{6}} + \frac{{c}_{0}}{2} k \{ 1 - tan h [ {c}_{1} ( {l}_{d} - ( {c}_{2} + \frac{{c}_{3}^{k}}{{c}_{4}} ) ) ] \} & ( 9 ) \\ {E}_{2} = {E}_{ref} + {E}_{off} & ( 10 ) \\ {p}_{b} = {d}_{0} + {d}_{1} \sqrt{k} & ( 11 ) \\ {E}_{n} = min ( {E}_{1} , {E}_{2} ) - {p}_{b} {log}_{10} ( 1 + {10}^{- \frac{\vert {E}_{1} - {E}_{2} \vert}{{p}_{b}}} ) & ( 12 ) \\ {E}_{fs} = 106.9 - 20 {l}_{d} & ( 13 ) \\ {E}_{b} = min ( {E}_{u} , {E}_{f 8} ) - 8 {log}_{10} ( 1 + {10}^{- \frac{\vert {E}_{u} - {E}_{fs} \vert}{8}} ) & ( 14 ) \\ Corrections = {C}_{e . r . p} + {C}_{{h}_{2}} + {C}_{urban} + {C}_{t . c . a} + {C}_{{h}_{1} < 0} & ( 15 ) \\ {E}_{c} = {E}_{b} + Corrections dB ( μV \text{/} m ) . & ( 16 )\end{matrix}$$

In the above equations, d and hl are in km and m, respectively. Efs is the free space field strength and Eb is the propagating field strength without considering the corrections (both for 1 kW effective radiated power). The parameters a0, a1, . . . , a3, b0, b1, . . . , b7, c0, c1, . . . , c6, d0 and d1 are given for nominal frequencies and time percentage in the recommendation. These coefficients are defined as the optimization parameters in the optimization algorithm. Ce.r.p., Ch2, Curban, Ct.c.a. and Ch1<0 are the corrections for effective radiated power, receiving/mobile antenna height, short urban/suburban paths, terrain clearance angle and negative values of hl, respectively. The related formulas for calculation of Ch2, Curban, Ct.c.a. and Ch1<0 can be found in [1]. The correction Ce.r.p. must be added to Eb, if the effective radiated power of the transmitter antenna is not equal to the nominal value of 1 kW:

$${C}_{e . r . p} = 10 {log}_{10} ( \frac{ERP}{1000} ) \qquad ( 17 )$$

An optimization algorithm was proposed and illustrated in this paper to tune the parameters of a given propagation model. This tuning method will be verified in comparison with the measurements performed by the UAV 1 equipped with a scanner utilizing the IS-95 pilot signal of a commercial CDMA mobile network in the rural environment.

### Report and Display of Field Strength Patterns

Applying the algorithms to convert vertical measurements into field patterns, the results may be displayed on a screen or on paper in a report. FIG. 5 shows a 3D pattern of signal strength as a visual representation of signal distribution in a space, and is derived from the present vertical testing method. The UAV 1 circles the antenna 17 (here shown as a directional antenna for showing the signal distribution within a quadrant) at various altitudes shown as circular flight paths 18a, 18b, 18c and 18d at different levels above ground, the flight path planes separated by vertical gaps 19a, 19b and 19c, again derived as a multiple of a wavelength.

The teardrop 3D pattern will preferably show either in grayscale or color a visual representation of field strength as it propagates outwardly from antenna 17. The preferred display convention is that light areas show less field strength, whereas darker areas show relatively stronger field strengths, with white area 20 showing substantially no signal. FIG. 6 shows two 3D views, 21 and 22, of an antenna pattern, in contrast to a 2D pattern 23 where the radiation source is supported by a monopole cell tower 24 in the form of a lattice.

For the purpose of dedicated scanning, a Sony Ericsson TEMS phone can go into a special scan mode which is not available in commercial phones and has superior performance to an ordinary cell phone. In scan mode, the channel selection is controlled by the user, unlike an ordinary phone mode which is controlled by the network.

### Interference Detection

Interference from both illegal and unintentional signals is a significant problem for mobile service providers, security services and government regulators. Interference can often degrade network performance, causing critical communications to be interrupted. Locating these sources of interference has traditionally been labor intensive and time consuming. Traditional methods include manually making numerous measurements from multiple locations using a directional antenna. Triangulation is then used to approximate the signal location. This process is then iterated a number of times until the interferer is precisely located.

Multiple measurements are automatically taken and processed. Using mapping software such as that resident on a Windows laptop/tablet, a mobile spectrum analyzer and an omnidirectional antenna, the system may provide directions and voice prompts to guide an engineer or field technician to the source of interference.

The various types of interference that the system may detect include low power, narrowband or wideband, modulated, pulsed signals similar to radar, signals hidden in LTE uplink channels, and “black” TV/radio station and base transceiver station (BTS) cellular equipment operating illegally.

Since other modifications or changes will be apparent to those skilled in the art, there have been described above the principles of this invention in connection with specific apparatus, it is to be clearly understood that this description is made only by way of example and not as a limitation to the scope of the invention.

What is claimed is:

1. A method for measuring radiation, comprising steps of:
determining a location of a radiation source;
moving an aerial vehicle along a first flight path at a first altitude proximate to the radiation source;
sensing a first radiation strength value emanating from the radiation source;
moving the aerial vehicle along a second flight path at a second altitude proximate to the radiation source;
sensing a second radiation strength value emanating from the radiation source;
storing the first and second strength values of radiation emanating from the radiation source and storing the first and second altitudes;
associating the first strength value with the first altitude, and the second strength value with the second altitude.

2. The method of claim 1, further comprising a step of transmitting the first and second strength values and the first and second altitudes to a receiver.

3. The method of claim 1, wherein the aerial vehicle traverses a circumference about the radiation source at the first altitude and at the second altitude.

4. The method of claim 1, further comprising a step of comparing the first strength value associated with the first altitude with the second strength value associated with the second altitude and applying an algorithm to determine a composite field strength value.

5. The method of claim 1, further comprising a step of rendering the first and second strength values in a three-dimensional display of a radiation pattern.

6. The method of claim 1, further comprising a step of sensing an interference signal and recording the interference signal.

7. A method for measuring radiation, comprising steps of:
determining a location of a radiation source;
moving an aerial vehicle along a first flight path at a first altitude proximate to the radiation source;
sensing a first radiation strength value emanating from the radiation source;
moving the aerial vehicle along a second flight path at a second altitude proximate to the radiation source;
sensing a second radiation strength value emanating from the radiation source;
transmitting the first and second strength values of radiation emanating from the radiation source and the first and second altitudes proximate to the radiation source to a base unit;
the base unit communicating with a processor to associating the first strength value with the first altitude, and the second strength value with the second altitude.

8. The method of claim 7, wherein the aerial vehicle traverses a circumference about the radiation source at the first altitude and at the second altitude.

9. The method of claim 7, further comprising a step of comparing the first strength value associated with the first altitude with the second strength value associated with the second altitude and applying an algorithm to determine a composite field strength value.

10. The method of claim 7, further comprising a step of rendering the first and second strength values in a three-dimensional display of a radiation pattern.

11. The method of claim 7, further comprising a step of sensing an interference signal and transmitting the interference signal.
